(19) United States
(12) Patent Application Publication
(10) Pub. No.: US 2025/0333359 A1
(43) Pub. Date: Oct. 30, 2025

(54) A METHOD OF CAPTURING CARBON DIOXIDE

(71) Applicant: CRH GROUP SERVICES LIMITED, Dublin 2 (IE)

(72) Inventors: Eldho Choorackal AVIRACHAN, Amsterdam (NL); Diego A. SANTAMARIA RAZO, Amsterdam (NL); José Amir GONZÁLEZ CALDERÓN, Mexico (MX); Mariana Gisela PEÑA-JUÁREZ, Mexico (MX)

(73) Assignee: CRH Group Services Limited, Dublin 2 (IE)

(21) Appl. No.: 18/879,827

(22) PCT Filed: Jun. 29, 2023
(86) PCT No.: PCT/EP2023/067873

§ 371 Date: Dec. 30, 2024

(30) Foreign Application Priority Data
Jun. 30, 2022 (EP) 22182319.8

(51) Int. Cl. C04B 20/02; C04B 14/06; C04B 14/28; C04B 14/30; C04B 20/10; C04B 28/04; C04B 111/00

(52) U.S. Cl. CPC C04B 20/0232; C04B 14/06; C04B 14/28; C04B 14/303; C04B 14/305; C04B 20/1022; C04B 28/04; C04B 2111/00019

(57) ABSTRACT

The present invention relates to a method of capturing carbon dioxide comprising:
a) providing a particulate material, wherein the particulate material comprises calcium carbonate and/or titanium dioxide,
b) providing a silane,
c) providing a surface activator,
d) mixing the particulate material and the surface activator to form a surface activated particulate material,
e) mixing the silane and the surface activated particulate material to form a mixture,
f) mixing water and the mixture to form a composition,
g) drying the composition to produce a carrier, and
h) treating the carrier with carbon dioxide.

The present invention relates a method for capturing carbon dioxide, a carrier with captured carbon dioxide, a method of forming an aqueous solution of carbonic acid, a method of producing mortar and a method of producing concrete.

### BACKGROUND TO THE INVENTION

The environmental impact of carbon dioxide is well known. There is a desire to reduce emissions of greenhouse gases, and in particular to reduce emissions of carbon dioxide. It is known to capture and store carbon dioxide, such as liquid carbon dioxide, however this requires a large amount of energy. It must be transported with care as liquid carbon dioxide will be at a low temperature and a high pressure.

There is a need for an efficient method of capturing carbon dioxide. There is a need to use captured carbon dioxide. There is a need to transport captured carbon dioxide. There is a need to reduce carbon dioxide emissions in construction. There is a need for an efficient way to produce mortar and concrete. There is a need to make a concrete composite which has improved strength. There is a need to reduce the amount of Portland cement and supplementary cementitious material used in the production of mortar and cement.

It is, therefore, an object of the present invention to seek to alleviate the above identified problems.

### SUMMARY OF THE INVENTION

In a first aspect of the invention, there is provided a method of capturing carbon dioxide comprising:
a) providing a particulate material, wherein the particulate material comprises calcium carbonate and/or titanium dioxide,
b) providing a silane,
c) providing a surface activator,
d) mixing the particulate material and the surface activator to form a surface activated particulate material,
e) mixing the silane and the surface activated particulate material to form a mixture,
f) mixing water and the mixture to form a composition,
g) drying the composition to produce a carrier, and
h) treating the carrier with carbon dioxide.

In a second aspect of the invention, there is provided a carrier with captured carbon dioxide produced by the method of the first aspect of the invention.

In a third aspect of the invention, there is a provided a method of forming an aqueous solution of carbonic acid comprising:
i) providing a carrier with captured carbon dioxide according to the second aspect of the invention or produced according to the method of the first aspect of the invention;
ii) providing water;
iii) mixing the carrier with captured carbon dioxide and water, such that carbon dioxide from the carrier with captured carbon dioxide is dissolved in the water to form an aqueous solution of carbonic acid.

In a fourth aspect of the invention, there is a provided a method of producing mortar comprising:
A. providing a carrier with captured carbon dioxide according to the second aspect of the invention, or produced according to the method of the first aspect of the invention;
B. providing a binder;
C. providing sand; and
D. mixing the carrier with captured carbon dioxide, the binder, the sand, and water to form mortar.

In a fifth aspect of the invention, there is a provided a method of producing concrete comprising:
I. providing a carrier with captured carbon dioxide according to the second aspect of the invention, or produced according to the method of the first aspect of the invention;
II. providing a binder;
III. providing an aggregate;
IV. mixing the carrier with captured carbon dioxide, the binder and the aggregate with water to form a wet mix; and
V. curing the wet mix to form concrete.

In a sixth aspect of the invention, there is provided a use of a carrier with captured carbon dioxide according to the second aspect of the invention, or produced according to the method of the first aspect of the invention in a method of making mortar or concrete.

The present invention relates to surface treating of a particulate material and use as a carrier to capture carbon dioxide. The carrier then releases the carbon dioxide into an aqueous solution of carbonic acid. This can then be used in a method of producing concrete and mortar.

### DETAILED DESCRIPTION

The present invention relates to a method of capturing carbon dioxide comprising:
a) providing a particulate material, wherein the particulate material comprises calcium carbonate and/or titanium dioxide,
b) providing a silane,
c) providing a surface activator,
d) mixing the particulate material and the surface activator to form a surface activated particulate material,
e) mixing the silane and the surface activated particulate material to form a mixture,
f) mixing water and the mixture to form a composition,
g) drying the composition to produce a carrier, and
h) treating the carrier with carbon dioxide.

This provides an efficient way to capture carbon dioxide. A carrier with captured carbon dioxide can be stored at ambient temperature and at atmospheric pressure. This allows the carrier with captured carbon dioxide to be easily stored or transported for use.

Preferably, the silane forms a coating on the particulate material, preferably the coating has a thickness between about 1 nm and about 5 nm, preferably about 2 nm to about 3 nm. Preferably the coating is substantially continuous. Preferably, the particulate material is silanized to form a carrier. This surface modification allows the carrier to capture carbon dioxide. It is particularly advantageous for the particulate material to comprise calcium carbonate or titanium dioxide as these can be used as a material for making concrete or mortar. In particular, calcium carbonate and carbon dioxide are both useful starting materials for making mortar or concrete. This allows the carbon dioxide to be readily available to react with, for example Portland cement hydration products to form calcium carbonate. Furthermore, the present invention is useful in improving the performance of mortar or concrete. Furthermore, calcium carbonate and titanium dioxide are both useful fillers in mortar or concrete.

Preferably, the silane is an amino silane, a phenol silane or a combination of two or more thereof, preferably an amino silane, preferably (3-Aminopropyl)triethoxysilane (APTES), (3-Aminopropyl) trimethoxysilane (APTMS), (3-Aminopropyl)methyldimethoxysilane, (3-Aminopropyl)methyldiethoxysilane, N-(2-aminoethyl)-3-aminopropylmethyldimethoxysilane, N-(2-aminoethyl)-3-aminopropyltrimethoxysilane, bis(3-trimethoxysilylpropyl)amine, diethylaminomethyltriethoxysilane, N-phenyl-3-aminopropyltrimethoxysilane, (N-phenylamino)triethoxysilane, or a combination of two or more thereof, preferably (3-Aminopropyl)triethoxysilane (APTES), (3-Aminopropyl) trimethoxysilane (APTMS) or a combination thereof. Such silanes are particularly preferred due to their molecular weight and polarity.

Preferably, the particulate material comprises calcium carbonate. Calcium carbonate is particularly preferred due to the amount of carbon dioxide that can be captured. Further, calcium carbonate is readily available and can be made into a particulate material.

Preferably, the particulate material comprises concrete fines. Concrete fines are a suitable source of calcium carbonate and it is advantageous to be able to recycle a waste material.

Preferably, the particulate material comprises titanium dioxide. Titanium dioxide is particularly preferred due to the amount of carbon dioxide that can be captured.

Preferably, the particulate material further comprises a metal oxide, preferably wherein the metal oxide comprises a calcium oxide, a silicon oxide, an aluminium oxide, or a combination of two or more thereof, preferably a calcium oxide. It is advantageous to include metal oxides in the production of mortar or concrete.

Preferably, the particulate material has an average particle size of less than about 50 μm, preferably in the range of from about 1 nm to about 50 μm, preferably in the range of from about 10 nm to about 10 μm, preferably in the range of from about 50 nm to about 500 nm. Such sizes balance the desire to have a large surface area to be silanized with the desire to have a particle size that can be used, such in the production of mortar or concrete.

Preferably average particle size is measured by laser diffraction.

Preferably, the carbon dioxide is captured by the carrier by adsorption and/or by absorption, preferably by adsorption. Preferably, the carbon dioxide is linked to the amino part of the silane. Preferably there is an electrostatic attraction between the amino part of the silane and carbon dioxide.

Preferably, the weight ratio of particulate material to silane is in the range of about 10:1 to 1:1, preferably in the range of about 7:1 to 1:1, preferably in the range of about 5:1 to 1:1, preferably about 1:1. These amounts are particularly preferred.

Preferably, the weight ratio of particulate material to silane is in the range of about 1:1 to 1:10, preferably in the range of about 1:2 to 1:8, preferably in the range of about 1:3 to about 1:7, preferably about 1:5. Such amounts allow the particulate material to be silanized and therefore capture carbon dioxide.

Preferably, steps d-f are sequential. This allows the particulate material to be activated, then treated with a silane and then the excess silane to be quenched by the addition of water.

Preferably the water in step f is added to the mixture with mixing. Preferably, the water in step f is added to the mixture in portions. Preferably the water is added to the mixture drop by drop. This helps control the polymerisation reaction of the silane.

Preferably, the volume ratio of the silane to the water in step f is in the range of about 1:1 to about 1:5, preferably in the range of about 1:1 to about 1:2. It is an advantage of the invention that silanization can occur with these amounts of water. Further, these amounts of water ensure that the silane has completely reacted as the silane typically reacts with water in about a 1:1 ratio.

Preferably, the surface activator comprises ethanol, methanol, acetone, a saline buffer solution or a combination of two or more thereof, preferably ethanol, methanol, acetone, or a combination of two or more thereof, preferably ethanol, methanol or a combination thereof, preferably ethanol. Such surface activators facilitate the activation of the surface of the particulate material. Preferably, hydroxy groups are bonded to the surface of the particulate material. These provide a suitable way to coat the particulate material with the silane.

Preferably, the weight ratio of the surface activator to the particulate material is in the range of about 4:1 to about 20:1, preferably in the range of about 5:1 to about 10:1. Such amounts are suitable for activating the surface.

Preferably, the weight ratio of the surface activator to the particulate material is in the range of about 2.5:1 to about 20:1, preferably in the range of about 2.5:1 to about 10:1, preferably in the range of about 2.5:1 to 5:1. Such amounts are suitable for activating the surface.

Preferably, there is less than about 5 wt % water present in step e, preferably less than about 2 wt % water, preferably about 0.1 wt % to about 2 wt % water. It is advantageous for there to be limited water present in step e to encourage polymerisation of the silane to take place at the surface of the particulate material.

Preferably, the mixture is a colloidal suspension, preferably a substantially homogenous colloidal suspension. This allows a uniform product to be produces. Further it encourages a substantially even level of silanization of the particulate material.

Preferably, step g comprises heating or filtering the mixture. Preferably step g comprises heating the mixture, preferably to a temperature in the range of about 30° C. to about 90° C., preferably in the range of about 40° C. to about 80° C., preferably in the range of about 50° C. to about 70° C.

Preferably step g is carried out for about 10 minutes to about 10 hours, preferably for about 1 hour to about 5 hours, preferably for about 2 hours to about 4 hours.

Preferably, after step g), the amount of free water present is less than 10 wt %, preferably less than 5 wt %, preferably less than 2 wt %. This helps stabiliser the carrier.

Free water is water that is not bound to another component. Free water does not include water which forms a hydrate.

Preferably, the method further comprises grinding or pulverising the carrier prior to step h). This increases the surface area of the carrier.

Preferably, the carrier has an average particle size of less than about 50 μm, preferably in the range of from about 1 nm to about 50 μm, preferably in the range of from about 10 nm to about 10 μm, preferably in the range of from about 50 nm to about 500 nm. This allows the particle size of the carrier to be chosen.

Preferably, the concentration of carbon dioxide provided in step h) is greater than about 2 vol %, preferably greater than about 10 vol %, preferably greater than about 20 vol %, preferably in the range of about 20 vol % to about 100 vol %, preferably in the range of about 50 vol % to about 100 vol %. Such levels allow for efficient capture of carbon dioxide.

Preferably, the concentration of carbon dioxide refers to the amount of carbon dioxide present in the gaseous phase.

Preferably, the amount of free water present in step h is less than 10 wt %, preferably less than 5 wt %, preferably less than 2 wt %. This helps stabiliser the carrier.

Preferably, the carbon dioxide is from flue gas. This is an environmentally friendly way of storing carbon dioxide produced by an industrial process. It is an advantage of the invention that this waste product can be recycled.

Preferably, step h) is carried out for about 1 minute to about 3 hours, preferably for about 5 minutes to about an hour. Such time frames are sufficient to ensure that the carrier captures carbon dioxide.

Preferably, the carrier with captured carbon dioxide comprises the silane. Preferably, the carrier with captured carbon dioxide comprises the particulate material, the silane and the carbon dioxide. It is an advantage of the invention that the silane remains part of the carrier as this helps capture the carbon dioxide.

Preferably, the temperature of step d, e and f is each independently in the range of about 10° C. to about 50° C., preferably in the range of about 15° C. to about 30° C., preferably in the range of about 20° C. to about 25° C. It is an advantage of the invention that it can be carried out at ambient temperatures and therefore does not require a large amount of energy to provide heat.

Preferably, the method is carried out at atmospheric pressure. It is an advantage that pressurised conditions are not required.

Preferably, the method is carried out at a pressure of between about 1 bar and about 3 bar.

The present invention further relates to a carrier with captured carbon dioxide produced by the method described herein.

The present invention further relates to a method of forming an aqueous solution of carbonic acid comprising:
i) providing a carrier with captured carbon dioxide as described herein;
ii) providing water;
iii) mixing the carrier with captured carbon dioxide and water, such that carbon dioxide from the carrier with captured carbon dioxide is dissolved in the water to form an aqueous solution of carbonic acid.

In this way, carbon dioxide can be released by the carrier and form carbonic acid. Carbonic acid can then react with Portland cement or other supplementary cementitious materials to cure mortar and/or concrete. It is an advantage of the invention that the carbonic acid aqueous solution is easily formed by adding the carrier with captured carbon dioxide to water.

The present invention further relates to a method of producing mortar comprising:
A. providing a carrier with captured carbon dioxide as described herein or produced according to a method as described herein;
B. providing a binder;
C. providing sand; and
D. mixing the carrier with captured carbon dioxide, the binder, the sand, and water to form mortar.

Preferably the binder is Portland cement and/or a supplementary cementitious material.

It is an advantage of the present invention that the carrier with captured carbon dioxide provides a readily available source of carbonic acid for reacting with a binder such as Portland cement and/or a supplementary cementitious material. This improves the speed of reaction because the carbonic acid is already available. Further, this means it is not necessary to provide more than atmospheric levels of carbon dioxide to cure the mortar. A higher concentration of carbon dioxide could be used, if required.

The present invention further relates to a method of producing concrete comprising:
I. providing a carrier with captured carbon dioxide as described herein or produced according to a method as described herein;
II. providing a binder;
III. providing an aggregate;
IV. mixing the carrier with captured carbon dioxide, the binder and the aggregate with water to form a wet mix; and
V. curing the wet mix to form concrete.

Preferably the binder is Portland cement and/or a supplementary cementitious material.

It is an advantage of the present invention that the carrier with captured carbon dioxide provides a readily available source of carbonic acid for reacting with a binder such as Portland cement and/or a supplementary cementitious material. This improves the speed of reaction because the carbonic acid is already available. Further, there is a faster strength gain, than when such a carrier with captured carbon dioxide is not used. This is due to accelerated cement hydration supported by the formation of calcium carbonate from carbon dioxide and calcium hydroxide. It is believed that the reaction of carbonic acid with calcium hydroxide forms calcium carbonate which acts as seeding points to enhance the rate of further hydration and thus curing of the concrete. Calcium hydroxide is formed during the hydration of a binder, such as Portland cement or a supplementary cementitious material. Further, the invention can use more fillers like calcium carbonate and titanium dioxide in concrete mixes without affecting strength due to the capture of carbon dioxide. This leads to a reduction in binder content, such as the amount of Portland cement or supplementary cementitious material.

Preferably, the concentration of carbon dioxide in step V is at least about 2 vol %, preferably about 5 vol % to about 100 vol %, preferably at about 15 vol % to about 80 vol %. Such levels increase the curing rate of the concrete, compared to atmospheric levels of carbon dioxide.

Preferably, step V is carried out in air. It is not necessary for excess carbon dioxide to be provided to cure the concrete.

Preferably, the aggregate has an average particle size of about 1 mm to about 60 mm, preferably about 5 mm to about 40 mm. Such sizes are suitable for forming concrete.

Preferably the aggregate comprises sand and an aggregate having an average particle size of about 1 mm to about 60 mm, preferably about 5 mm to about 40 mm.

Preferably, the aggregate comprises sand and gravel.

The present invention further relates to the use a carrier with captured carbon dioxide described herein in a method of making mortar or concrete.

### BRIEF DESCRIPTION OF THE DRAWINGS

Example embodiments of the present invention will now be described with reference to the accompanying figures, in which:

FIG. 1 shows a schematic of a silane adsorbed on the surface of a particulate material

FIG. 2 shows a schematic of pretreatment of a particulate material with ethanol prior to a silane adsorbed on the surface of a particulate material

FIG. 3 shows infrared spectra of the samples

FIG. 4 shows high resolution transmission electron microscopy micrographs of the samples

FIG. 5 shows the turbidity of the samples

FIG. 6A-6C shows the z-potential of the samples

FIG. 7 shows infrared spectra of the samples

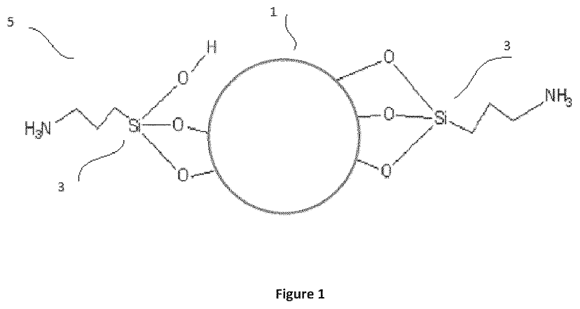

FIG. 1 shows a schematic of a carrier 5 comprising a silane 3, particularly an amino silane, adsorbed onto the surface of a particulate material 1.

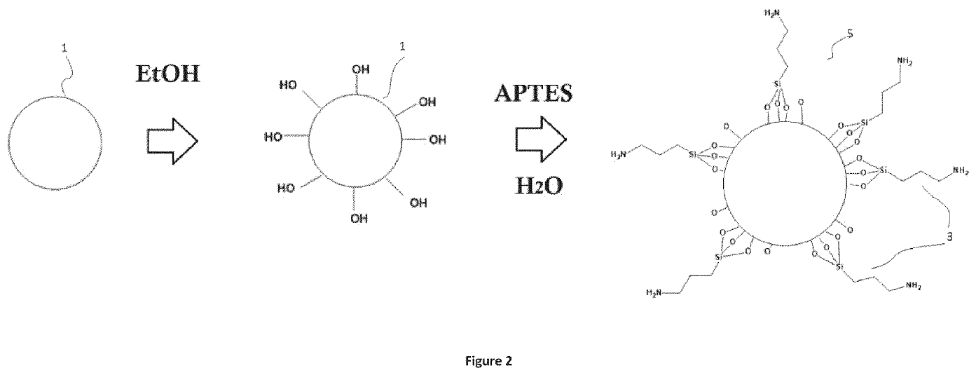

FIG. 2 shows a schematic of pretreating a particulate material 1 with ethanol, prior to adding a silane 3, particularly an amino silane, particularly APTES and water to form a carrier 5.

### EXAMPLES

Example embodiments of the present invention will now be described with reference to the accompanying Examples.

### Example 1

5 g of a particulate material was added to 30 ml of ethanol and stirred. 1 g of APTES and then 1 g of water were added to form a carrier. The ratio of particulate material to silane was 5:1 The carrier was dried. The carrier was then treated with carbon dioxide at a concentration of 99.8% purity for 2 minutes to form a carrier with captured carbon dioxide.

Comparative Examples were carried out by treating 5 grams of particulate material with 2 mL/min carbon dioxide at a concentration of 99.8% purity for 2 minutes.

Table 1 shows the pH of various particulate materials. 5 g of each sample was mixed with 100 ml of water and the pH was measured after 5 to 10 minutes.

TABLE 1

| | pH of Comparative | pH of carrier with |
|---|---|---|
| Particulate material | examples (no silane) | captured CO2 |
| Micro calcium carbonate | 6 | 5.4 |
| Nano titanium dioxide | 6 | 5.2 |
| Nano silicon dioxide | 6.2 | 5.6 |
| Nano aluminium oxide | 6.4 | 5.6 |
| Nano calcium carbonate | 6 | 5.2 |

The results indicate that the carrier with captured carbon dioxide has a lower pH than a particulate material that had not been pretreated with a silane. This evidences that the silane pretreatment allows the carrier to capture carbon dioxide and the carbon dioxide then dissolves in the water to form an aqueous solution of carbonic acid.

### Example 2

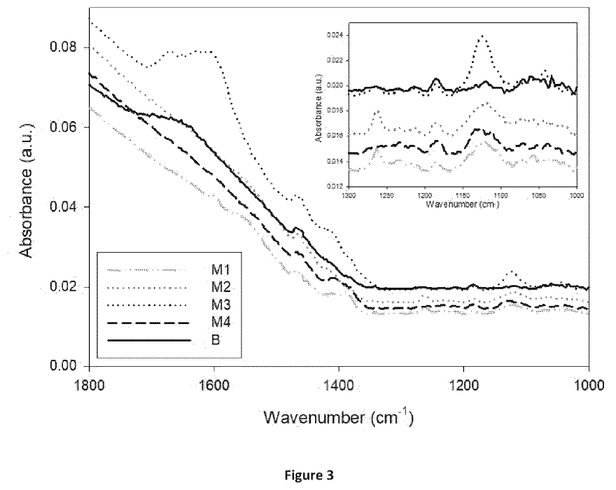

This example uses titanium dioxide as the particulate material and were processed as set out in Example 1. The results are indicative of other particulate materials such as calcium carbonate. Table 2 shows the samples used in this example. Samples M1 to M4 were treated with ethanol, water and APTES and then dried. The infrared spectra of the samples is shown in FIG. 3. The higher the absorbance, the greater the amount of silane on the surface of the sample. Surprisingly, sample M3 showed the greatest amount of silane present.

TABLE 2

| Sample | TiO₂ (g) | APTES (mL) |
|---|---|---|
| B (comparative example) | 1 | 0 |
| M1 | 0.5 | 1 |
| M2 | 1 | 1 |
| M3 | 5 | 1 |
| M4 | 10 | 1 |

### Example 3

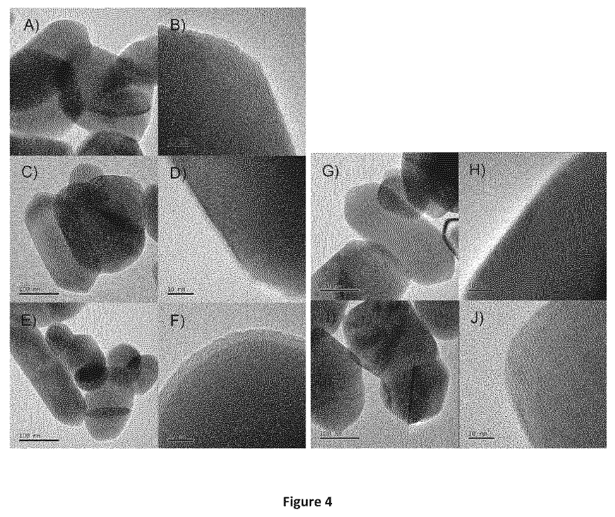

FIG. 4 shows High resolution transmission electron microscopy micrographs of the samples which show the coated particulate material. The samples are labelled in Table 3.

TABLE 3

| Sample | Image |
|---|---|
| B | A and B |
| M1 | C and D |
| M2 | E and F |
| M3 | G and H |
| M4 | I and J |

### Example 4

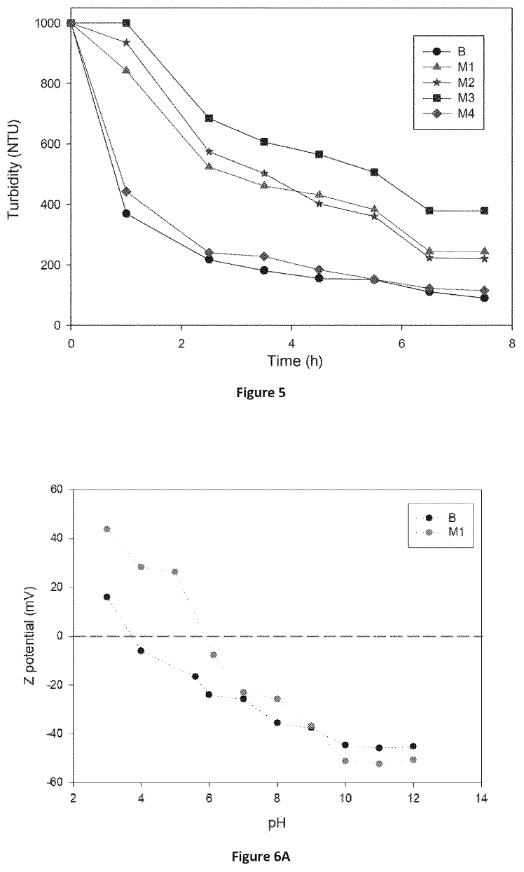

The samples were then added to water and their turbidity was measured. The results are shown in FIG. 5. The more turbid the sample is, the greater the level of dispersion. It is preferred that the level of dispersion is high. This leads to a more homogenous suspension and therefore a more even reaction when subsequently making mortar or concrete. M3 shows the best performance.

### Example 5

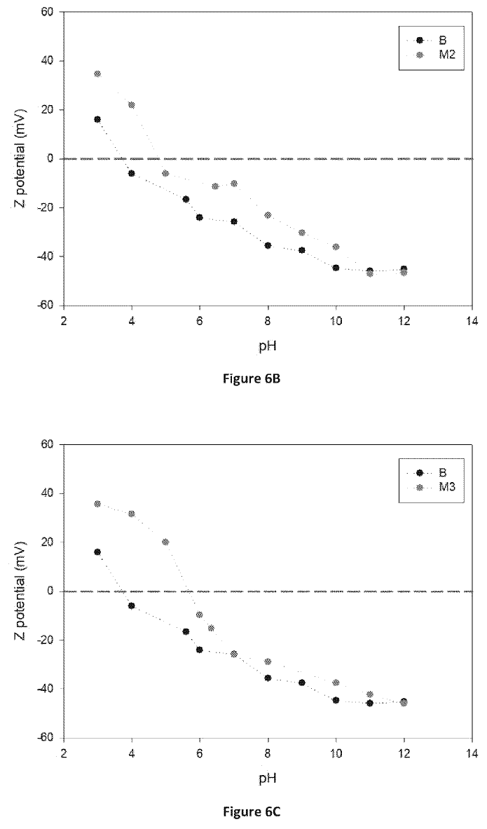

The z-potential of the samples was measured with changing pH. A higher z-potential shows a higher level of dispersion. All of samples M1-M3 show a higher level of dispersion than the comparative sample B as shown in FIGS. 6A-6C.

### Example 6

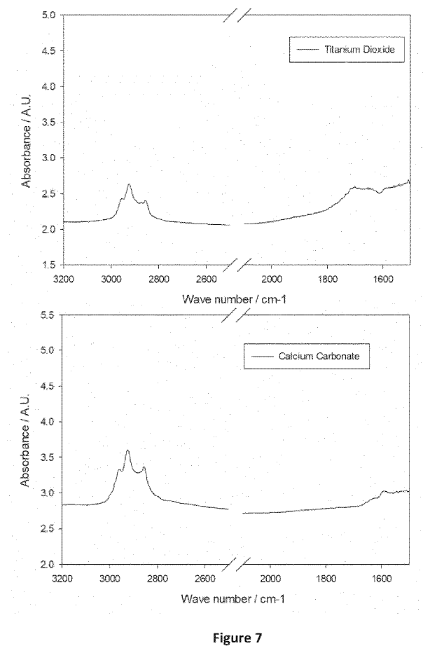

The infrared spectra of Sample M3 (titanium dioxide) was measured and is shown in FIG. 7. This was compared to a Sample of calcium carbonate that was treated as per M3, that is with a 5:1 ratio of particulate material to silane. This figure shows that when the particulate material is calcium carbonate, a larger amount of silane appears to be absorbed than when titanium dioxide is used. A higher peak is indicative of a greater amount of silane.

### Example 7

This example uses micro calcium carbonate as the particulate material. 100 g of micro calcium carbonate (D90=40 μm) was added to ethanol (the surface activator) and stirred. Next, APTES and subsequently 100 ml of water were added to form a carrier. The carrier was dried and then treated with carbon dioxide as described in Example 1 to form a carrier with captured carbon dioxide. The ratios of particulate material to APTES and ethanol to particulate material are set out in Table 4.

### Table 4

Table 4 shows how the ratios of particulate material to silane and surface activator to particulate material affect carbon dioxide uptake. The results show that carbon dioxide uptake is increased using greater amounts of APTES.

| Particulate | Surface activator/ | Carbon dioxide |
|---|---|---|
| material/APTES | particulate material | uptake (%) |
| 10:1 | 2.5:1 | 2.1 |
| 10:5 | 5:1 | 2.9 |
| 10:3 | 4:1 | 2.6 |
| 10:5 | 2.5:1 | 3.8 |
| 10:1 | 5:1 | 1.6 |
| 10:3 | 4:1 | 2.6 |
| 10:3 | 4:1 | 2.7 |
| 10:3 | 4:1 | 2.9 |
| 10:3 | 4:1 | 2.6 |
| 10:1 | 2.5:1 | 2.3 |
| 10:5 | 5:1 | 3.0 |
| 10:1 | 5:1 | 1.7 |
| 10:5 | 2.5:1 | 3.9 |

### Example 8

This example uses micro calcium carbonate as the particulate material, processed according to the method set out in Example 7. The mechanical strength of cement mortar samples prepared using the carrier was measured and is shown in Table 5. Mechanical strength was measured after 28 days, with the carbonated cement mortar sample showing a clear increase in mechanical strength compared to the reference sample. This evidences that the present invention produces a composite which has improved strength.

| | Compressive strength after |
|---|---|
| | 28 days/MPa |
| Cement mortar reference | 55.7 |
| Carbonated cement mortar | 58.3 |
| reference | |

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein and vice versa.

Within this specification, the term “about” means plus or minus 20%, more preferably plus or minus 10%, even more preferably plus or minus 5%, most preferably plus or minus 2%.

Within this specification, the term “substantially” means a deviation of plus or minus 20%, more preferably plus or minus 10%, even more preferably plus or minus 5%, most preferably plus or minus 2%.

Within this specification, reference to “substantially” includes reference to “completely” and/or “exactly”. That is, where the word substantially is included, it will be appreciated that this also includes reference to the particular sentence without the word substantially.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications are covered by the appended claims.

1.-15. (canceled)

16. A method of capturing carbon dioxide comprising:
a. providing a particulate material, wherein the particulate material comprises calcium carbonate and/or titanium dioxide,
b. providing a silane,
c. providing a surface activator,
d. mixing the particulate material and the surface activator to form a surface activated particulate material,
e. mixing the silane and the surface activated particulate material to form a mixture,
f. mixing water and the mixture to form a composition,
g. drying the composition to produce a carrier, and
h. treating the carrier with carbon dioxide.

17. A method according to claim 16, wherein the silane is an amino silane, a phenol silane or a combination of two or more thereof.

18. A method according to claim 16, wherein the silane is (3-Aminopropyl)triethoxysilane (APTES), (3-Aminopropyl) trimethoxysilane (APTMS), (3-Aminopropyl)methyldimethoxysilane, (3-Aminopropyl)methyldiethoxysilane, N-(2-aminoethyl)-3-aminopropylmethyldimethoxysilane, N-(2-aminoethyl)-3-aminopropyltrimethoxysilane, bis(3-trimethoxysilylpropyl)amine, diethylaminomethyltriethoxysilane, N-phenyl-3-aminopropyltrimethoxysilane, (N-phenylamino)triethoxysilane, or a combination of two or more thereof.

19. A method according to claim 16, wherein the particulate material further comprises a metal oxide.

20. A method according to claim 19, wherein the metal oxide comprises a calcium oxide, a silicon oxide, an aluminium oxide, or a combination of two or more thereof.

21. A method according to claim 16, wherein the particulate material has an average particle size of less than about 50 μm.

22. A method according to claim 16, wherein the carbon dioxide is captured by the carrier by adsorption and/or by absorption.

23. A method according to claim 16, wherein the weight ratio of particulate material to silane is in the range of about 10:1 to 1:1.

24. A method according to claim 16, wherein the volume ratio of the silane to the water in step f is in the range of about 1:1 to about 1:5.

25. A method according to claim 16, wherein the surface activator comprises ethanol, methanol, acetone, a saline buffer solution or a combination of two or more thereof.

26. A method according to claim 16, wherein the weight ratio of the surface activator to the particulate material is in the range of about 2.5:1 to about 20:1.

27. A method according to claim 16, wherein the silane forms a coating on the particulate material.

28. A method according to claim 16, wherein the carrier has an average particle size of less than about 50 μm.

29. A method according to claim 16, wherein the concentration of carbon dioxide provided in step h) is greater than about 2 vol %.

30. A method according to claim 16, wherein step h) is carried out for about 1 minute to about 3 hours.

31. A carrier with captured carbon dioxide produced by the method of claim 16.

32. A method of forming an aqueous solution of carbonic acid comprising:
i. providing a carrier with captured carbon dioxide according to claim 31;
ii. providing water;
iii. mixing the carrier with captured carbon dioxide and water, such that carbon dioxide from the carrier with captured carbon dioxide is dissolved in the water to form an aqueous solution of carbonic acid.

33. A method of producing mortar comprising:
A. providing a carrier with captured carbon dioxide according to claim 31;
B. providing a binder;
C. providing sand; and
D. mixing the carrier with captured carbon dioxide, the binder, the sand, and water to form mortar.

34. A method of producing concrete comprising:
I. providing a carrier with captured carbon dioxide according to claim 31;
II. providing a binder;
III. providing an aggregate;
IV. mixing the carrier with captured carbon dioxide, the binder and the aggregate with water to form a wet mix; and
V. curing the wet mix to form concrete.

35. A method according to claim 34, wherein the aggregate has an average particle size of about 1 mm to about 60 mm.

36. Use of a carrier with captured carbon dioxide according to claim 26, in a method of making mortar or concrete.
